(19) United States
(12) Patent Application Publication
(10) Pub. No.: US 2007/0040390 A1
(43) Pub. Date: Feb. 22, 2007

(54) Door catch

(76) Inventor: Milan Pilja, Woodville West (AU)

Correspondence Address: NATH & ASSOCIATES, 112 South West Street, Alexandria, VA, 22314, US

(21) Appl. No.: 10/578,722

(22) PCT Filed: Nov. 10, 2004
(86) PCT No.: PCT/AU04/01547

§ 371 Date: Aug. 28, 2006

(30) Foreign Application Priority Data
Nov. 10, 2003 (AU) 2003906173

(51) Int. Cl. E05C 5/00

(52) U.S. Cl. 292/68

(57) ABSTRACT

A door catch (10) for a multiple panel covered door (44) wherein there is a wheel (20) rotationally mounted at an outer end an optionally resiliently deflectable support arm (14, 18) for rotational movement of the wheel about an axis parallel to the plane of the door, the arm adapted to be secured to the outer end of a door and where the wheel has an outer circumference provided by a plurality of radially extending portions.

The present invention relates to improvements in door catches and installations having a door catch and in particular to door catches that are intended to be used for corner cabinet doors.

In the construction of cabinets, and in particular kitchen cabinets, it is very desirable to have an attractive finish on the outside of the cupboard door in order to improve the esthetical qualities of the room as a whole. In order to be able to provide high quality finishes many cabinet manufacturers apply a veneer of material over the cabinet structure, such as the door, where the veneer material is quite different to that from which the cabinet is constructed. In many instances the cabinet is simply constructed from “chip board” or similar inexpensive material and, the veneer is either a timber veneer or a plastics veneer.

In either case, the veneer itself, by definition, is a relatively thin layer of material and therefore can be susceptible to damage by scratching from harder materials.

In many cabinet installations, and especially in the installation of cabinets in kitchens, there is typically installed a corner cabinet unit in which the two doors are connected to each other by a hinge so that the door that is not connected to the cabinet structure is typically referred to as a “floating door”. The purpose of these doors is that they allow greater access into the corner cabinet unit therefore making better use of the space within that unit.

One of the problems with such corner units is that what inevitably happens is the rear of the “floating door” may contact an adjacent door or panel and the fittings or fastenings on the rear of the “floating door” can scrape or gouge across a face of the adjacent door or panel thereby causing wear or sometimes damage to an edge of the vulnerable thin veneered face.

Furthermore, an appropriate door catch can be employed in such a way so that, over time, a bi-fold door system is supported against twist or sag due to the extra weight of the “floating door” on the hinge system.

Magnetic catches have been employed to assist a “floating door” to be held sufficiently to reduce the amount of sagging or twisting of the “floating door”.

It has been known to attach a rotationally supported roller to a rear facing surface of a bi-fold door such that when the bi-fold doors are being closed an outer edge of the roller contacts the adjacent door or surface and rolls over the edge therefore limiting damage done to the veneered surface or the vulnerable edge.

However, the roller wheel will still ride around a corner and therefore vulnerable edge of an adjacent door or panel. Such corners or edges as has been said are very susceptible to damage as this is where the two veneered surfaces meet and over time repetitive striking by the roller can damage this weak spot, ultimately resulting possibly in the veneer lifting from the adjacent door or structure.

One approach has been to provide a door catch assembly, consisting of separate units namely a roller unit and a catch unit, wherein the roller unit is attached to the inside surface of the “floating panel” of a bi-fold door system. The catch unit is then installed to the interior panel that the floating door abuts in the closed position. However, such an arrangement is relatively time consuming and tricky to install in that the roller unit and catch units are required to be specifically mutually aligned so that they may appropriately interact with each other to prevent the bi-fold door unit from sagging.

An object of the present invention to provide an improved door catch for the purposes described that will facilitate a reduction in wear or damage to adjacent panels or doors.

At the least it is an object to at least reduce at least some of the above problems or provide the public with a useful alternative.

In one form of the invention, although this may not necessarily be the only or indeed the broadest form, there is proposed an installation of a door catch with a multiple panel covered doors wherein there is a wheel supported at an outer end of the door and arranged to interengage with a cupboard frame or side to thereby hold the door closed, characterised in that the wheel has an outer circumference provided by a plurality of radially extending portions.

In preference the radially extending portions are each separately resiliently divertible one with respect to the other.

This arrangement then lets the respective portions have an implicit radially directed resiliency with respect to a rotational axis of the wheel.

Further, this effect is combined with an ability then to ride around an edge where adjacent portions will by reason of their shape and support be adapted to splay as the wheel is pulled around an edge and it is found that this splaying allows the wheel to be drawn around the edge with at least a reduced resilient pressure against the edge itself that is vulnerable to wear or damage.

This then presumes that the portions are of a shape that will facilitate this effect and in preference then the portions are each long and thin and are either made from a resilient plastics material or are otherwise constructed to allow for this resilient effect. This then further allows for the joint purpose to be achieved of reducing wear of an adjacent corner surface and also have resiliency which can then further be used to assist in holding the door closed. The resiliency can also be assisted by having a resilient support structure.

In preference, the portions are vanes are approximately planar and are aligned so as to be at least approximately parallel to an axis of rotation of the wheel and extending radially from the said axis.

In preference, the portions are each resiliently deflectable one with respect to the other.

In preference, the wheel is rotatably supported by an arm, which is supported by a base such that the arm is adapted to be resiliently deflectable relative to the base.

In the alternative the invention can be said to reside in a door catch for a multiple panel covered door wherein there is a wheel rotationally supported at an outer end of a support arm which is adapted to be secured to the outer end of a door and where the wheel has an outer circumference provided by a plurality of radially extending portions.

In preference, the door catch includes a body member having a base portion adapted to be secured to a vertical inner surface of a cabinet door, a projecting arm projecting from the base member and a roller pivotally mounted to the projecting arm portion to enable rotation about an axis parallel to a plane of a cabinet door.

In preference the catch is such that in use, when a cabinet door is being closed, the pivotally or rotationally mounted roller contacts an inner surface substantially perpendicular to that of the cabinet door and the projecting arm portion is deflected such that the pivotally mounted roller urges against the substantially perpendicular inner surface to provide a resistance force against movement of the cabinet door relative to the inner surface so as to hold the cabinet door in its closed position.

In a further form the invention resides in an installation where there is a catch secured to a bi-fold door where the catch includes a body member having a base portion adapted to be secured to a vertical inner surface of a cabinet door, a projecting arm projecting from the base member and a roller pivotally mounted to the projecting arm portion to enable rotation about an axis parallel to a plane of a cabinet door

In preference, the multi panel covered door is a bi-fold door.

In preference, the bi-fold door closes off a corner opening of a cabinet structure.

In preference, the projecting arm portion extends away from an end of the base portion at an angle of approximately 45 degrees.

In preference, the base member and projecting arm are integrally molded from plastics material.

In preference, the plastics material has resiliently deflectably properties.

In preference, the radially extending portions are tapered so they are thicker at their base.

In a further embodiment, the invention can be said to reside in a fitting for multiple panel doors which includes a base rotatably supporting at least one wheel, wherein the at least one wheel has an outer circumference provided by a plurality of radially extending portions.

In preference, the radially extending portions are each resiliently deflectable one with respect to the other.

In preference, the wheel is rotatably supported by an arm which is supported by a base such that the arm is adapted to be resiliently deflectable relative to the base.

In preference, the radially extending portions are in the form of vanes or paddles which are aligned so that they are deflectable about an axis which is parallel to the axis of rotation of the wheel.

In another embodiment, the invention can be said to reside in an arrangement for multiple panel cupboard doors where there is a wheel supported at an outer end of the door and adapted to interengage with the cupboard frame or side to thereby hold the door closed, characterised in that the wheel is supported relative to the door by an arm which is resiliently deflectable with respect to a supporting base.

In preference, the arm is integral with the base.

In preference, the base and arm are together made from a resilient plastics material and are formed so as to allow for relative resilient deflection between the two.

By way of illustration only, an embodiment of the invention is described more fully hereinafter with reference to the accompanying drawings in which

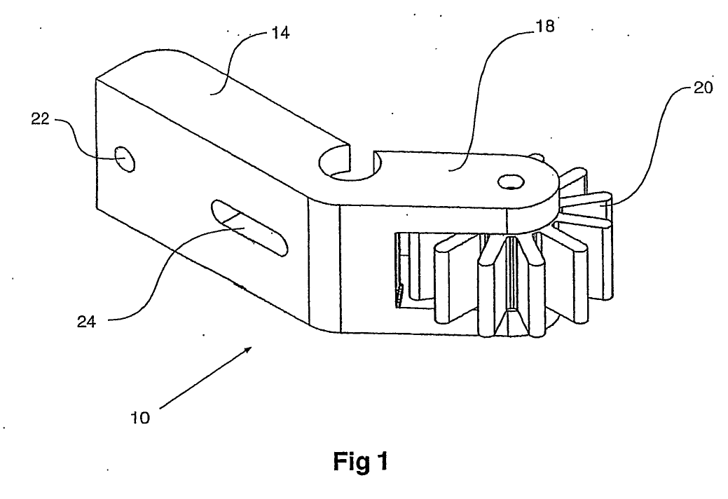

FIG. 1 is a perspective view of the improved door catch according to a preferred embodiment of the invention,

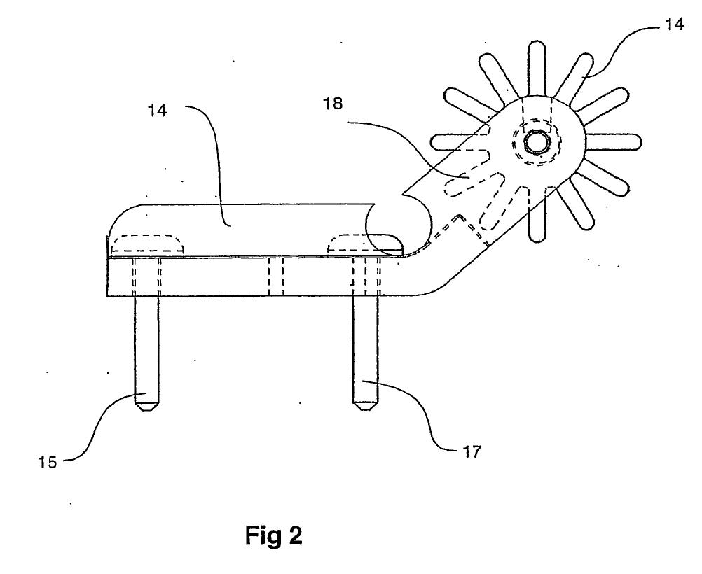

FIG. 2 is a side view of the device as shown in FIG. 1,

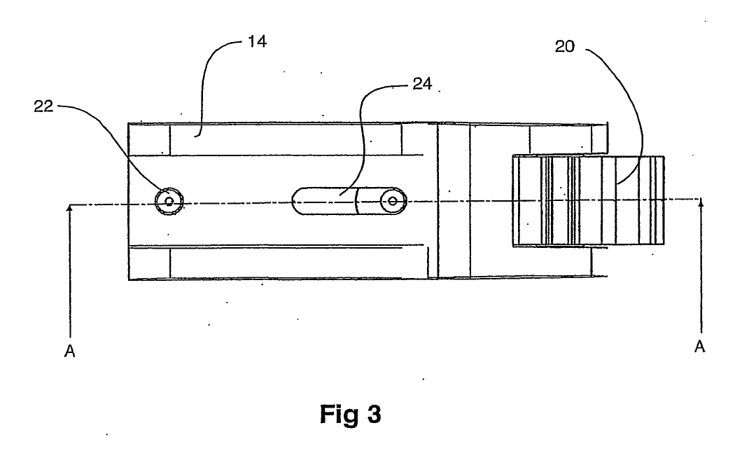

FIG. 3 is an underside view of the device,

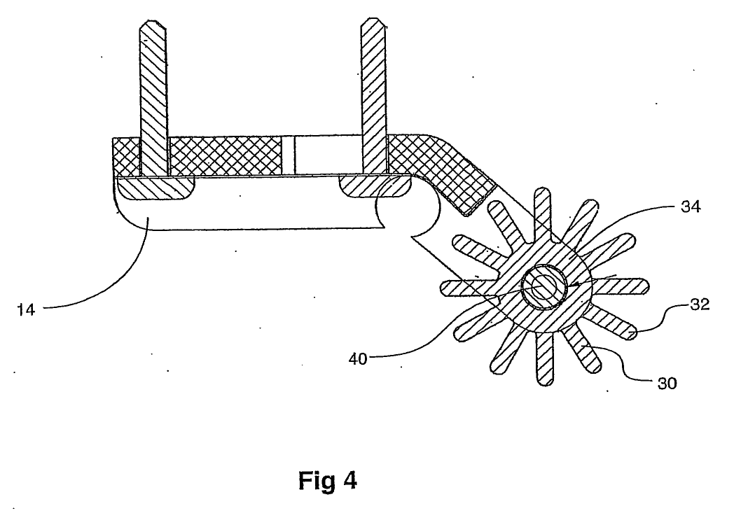

FIG. 4 is a cross sectional view through A-A in FIG. 3,

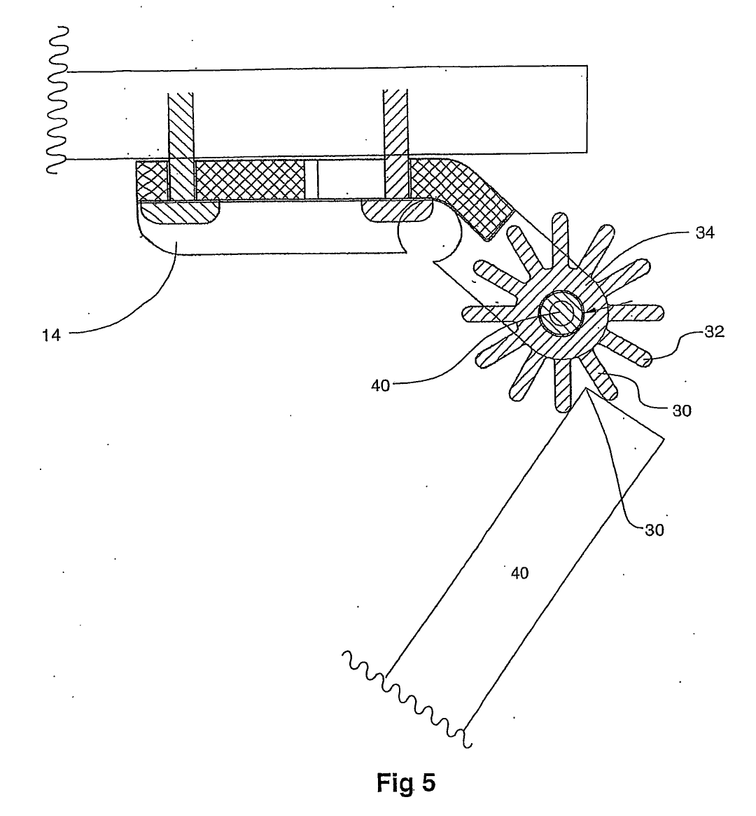

FIG. 5 shows the cross sectional view of FIG. 3 and the interaction with a corner,

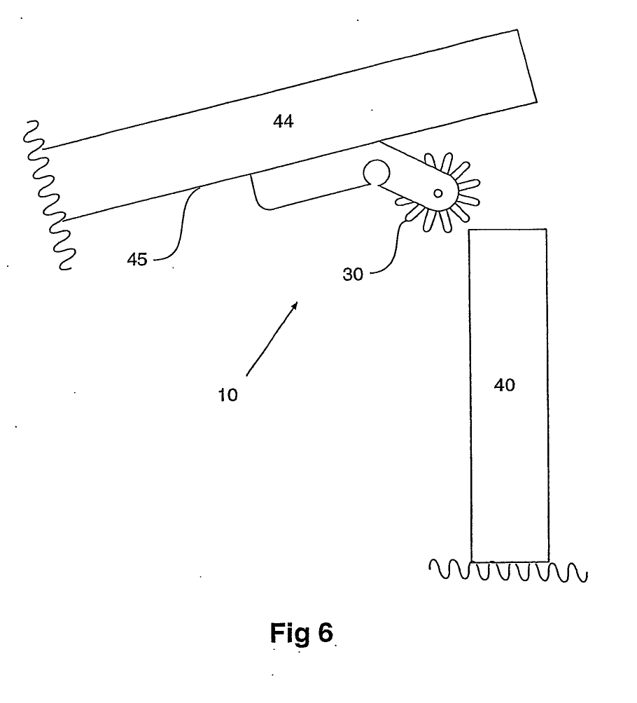

FIG. 6 is a similar view to FIG. 5, showing the improved door catch attached to the inside of a cabinet door, and

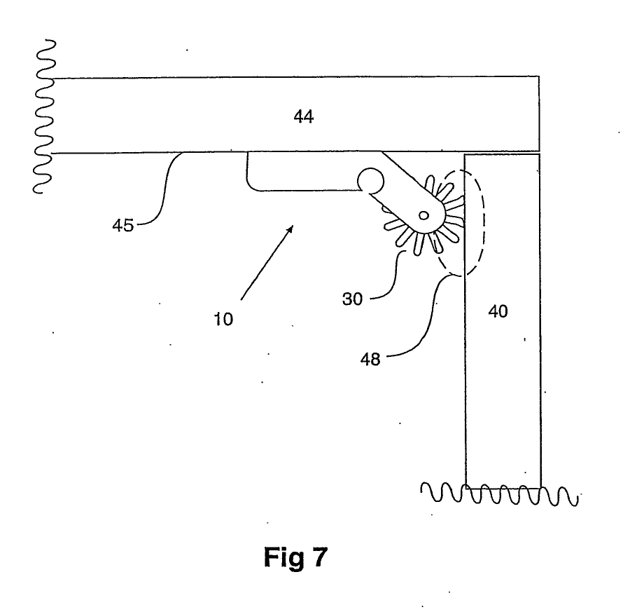

FIG. 7 shows the cabinet door in the closed position,

FIG. 8 is a perspective view of a further embodiment of the invention,

FIG. 9 is a side view of the device shown in FIG. 8,

FIG. 10 is a cross sectional view of the device shown in FIG. 9.

The door catch 10 comprises a base portion 14 and a projecting arm portion 18, to which is attached a wheel 20. The base portion 14 and projecting arm portion 18 are integrally moulded from a plastics material which is selected from a plastic that is sufficiently strong for the purpose, may be injection moulded and allows for an extent of resiliency which in this case for a pressure in an horizontal direction against the arm Suitable plastics materials include both ABS or Nylon with 15-20% glass. Other plastics materials may be employed without departing from the scope of the invention

The base portion 14 has apertures 22 and 24 for receiving fastening members there through so that the door catch 10 can be securely fastened to the inside of a cabinet door.

The projecting arm 18 is set at an angle of approximately 45 degrees away from the plane of the base portion 14, such that when attached to the inside of a cabinet door 45 the projecting arm 18 sits away from the cabinet door 44. The wheel 20 has a plurality of radially extending portions referred to as vanes 30 or paddles. The wheel 20 has 12 vanes and each of the vanes 30, which are each of the same size, has a free end 32 and each vane 30 radiates from the central portion 34 of wheel 20. Further each of the vanes has a slightly rounded end which is intended to assist when the end may engage against a corner so that there is little chance that this will directly engage on an edge of a corner and if it does then it will slide off the corner relatively easily. The angle and distance in between each vane 30 and the length of each of the vanes is as shown and is such that when the wheel 30 encounters a corner 36 the vanes 30 are positioned such that they will sit, or splay either side of edge 36 so as to minimise contact with the corner itself, which is normally where the veneer faces meet on cabinets constructed using veneered surfaces.

The angle of the projecting arm 18 may vary according to the area to which the catch 20 is to be inserted. In some installations, angles of less than 45° will be suitable.

The wheel 20 is constructed from a rubber or plastics type material that is resilient enough so that the vanes 30 will splay 48 when in contact about edge 36 or the inner surface of panel 40 and yet not wear excessively or damage any surface that it comes into contact with. Such a material is polyurethane with a Shore A measurement of approximately 95.

The door catch 10 has two apertures, 22 and 24, adapted to receive fastening members, 15 and 17, therethrough. This then facilitates the installation of the door catch 10 as it is a single unit that does not need to align with another separate unit or device apart from the plane of the inside cupboard surface which is to be caught by the device 10. As will be readily appreciated by those skilled in the trade, the need to only install a single component will therefore reduce the time required to install the door catch 10.

In use, when door catch 10 is securely attached to the inside of a cabinet door, in the closing operation of the door then the vanes 30 come into contact with the panel 40 which results in vanes 30 becoming splayed 48. The splaying action of the vanes 30 applies a force to the inside surface of panel 40 such that the door 44 is held in place.

Depending on the degree of force applied to the vanes 30, this then may deflect the projecting arm portion 18 away from its resting position such that it then urges roller 20 against panel 40 with sufficient pressure to hold the door in a closed position.

In the event that two multi panel doors are to abut each other, then in order to provide the equivalent surface section of panel 40 for the wheel 20 to urge against, a small block or other such flat surface may be attached to a shelf or horizontal surface within the cabinet so that the door catch 10 can urge against this.

The base portion 14 and projecting arm portion 18 are integrally molded from a resilient plastics material such as nylon and shaped so that the projecting arm portion 18 has the ability to deflect under pressure. In contrast, the wheel 20 is constructed from relatively soft resilient plastics material.

A further embodiment is shown in FIG. 10, wherein the door catch 100 has a base portion 110 and two projecting members 120 and 130 respectively that are substantially perpendicular to the base portion 110. Each projection member 120 and 130 has a hole 140 located toward an upper end 150 of the respective projecting member, the middles of the holes 150 being in alignment with one another. The projecting arms 120 and 130 are located towards the front side 160 of the base portion 110 so as to bring the axis 170 that the wheel 180 closer to the plane of the front side 160.

Between the projection members (or arms) 120 and 130, the base section 110 is substantially concave 190 to allow for the vanes 185 of wheel 180 to rotate freely about axis 170 without being impeded by the base portion 110. Additionally, the effect of the substantially concave section 190 is that it allows for the length of the projecting arms 120 and 130 to be reduced such that they do not protrude as much. This then allows for a smaller, neater device, and places less strain on the projecting members 120 and 130 during operation.

The door catch 100 has two apertures, 220 and 230, adapted to receive fastening members therethrough. This then facilitates the installation of the door catch 100 as it is a single unit that does not need to align with another separate unit or device, apart from the plane of the inside cupboard surface which is to be caught by the device 100. As will be readily appreciated by those skilled in the trade, the need to only install a single component will therefore reduce the time required to install the door catch 100.

The wheel 180 is constructed from a rubber or plastics type material that is resilient enough so that the vanes 180 will splay when in contact about edge or the inner surface of panel and yet not wear excessively or damage any surface that it comes into contact with. Such a material is polyurethane with a Shore A measurement of approximately 95.

Clearly there may be other types of material that achieve the desired result of non-mark and resiliency and flexibility required to perform in an adequate fashion

Although the invention has been herein shown and described in what is conceived to be the most practical and preferred embodiment, it is recognised that various modifications may be made in details of design and construction without departing from the scope and ambit of the invention.

1. A door catch for attachment to swinging cabinet door wherein there is a wheel supported at an outer end of the door characterized in that the wheel has an outer circumference provided by a plurality of radially extending portions adapted to urge against a cabinet frame or side to thereby hold the door closed.

2. A door catch as in claim 1, further characterized in that the radially extending portions are vanes that are aligned so as to be at least approximately parallel to the axis of the wheel.

3. A door catch as in claim 2, wherein the radially extending portions are approximately planar and are aligned so as to be at least approximately parallel to an axis of rotation of the wheel and extending radially from the said axis.

4. A door catch as in claim 3, further characterized in that the radially extending portions are each resiliently deflectable one with respect to the other.

5. A door catch as in claim 1, the radially extending portions are tapered so they are thicker at their base.

6. A door catch as in claim 5, further characterized in that the cabinet door is a multi panel door or a bi-fold door.

7. A door catch as in claim 6, wherein the bi-fold door closes off a corner opening of a cabinet structure.

8. A door catch as in claim 7, further including a body member having a base portion adapted to be secured to an inner surface of the door, a projecting from the base member supporting the wheel for pivotal movement of the wheel about an axis parallel to the plane of the cabinet door; such that in use, when the cabinet door is being closed, the wheel contacts an inner surface substantially perpendicular to that of the cabinet door and the projecting arm portion is deflected such that the radially extending portions of the wheel urge against the substantially perpendicular inner surface to provide a resistance force against movement of the cabinet door relative to the inner surface so as to hold the door in a closed position.

9. A door catch as in claim 8, wherein the projecting arm portions extends away from an end of the base portion at an angle of approximately 45 degrees.

10. A door catch as in claim 6, wherein the base portion and projecting arm are integrally molded from plastics material.

11. A door catch as in claim 10, wherein the plastics material has resiliently deflectable properties.

12. An improved door catch substantially as hereinbefore described with reference to the drawings.
